(19) United States
(12) Patent Application Publication
(10) Pub. No.: US 2003/0230174 A1
(43) Pub. Date: Dec. 18, 2003

(54) INNER PERIPHERY OF A DRIVING MEMBER FOR DRIVING NUT WITH DIFFERENT SPECIFICATIONS

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/167,454

(22) Filed: Jun. 13, 2002

(51) Int. Cl. B25B 13/46

(52) U.S. Cl. 81/60

(57) ABSTRACT

A driving member for a wrench tool includes a ring-shaped body having a hole defined therethrough and six concavities are defined equiangularly in an inner periphery of the ring-shaped body. Six engaging portions are located between the six concavities alternatively and each engaging portion includes a first engaging surface and a second engaging surface on two ends of the engaging portion. The two engaging surfaces are respectively matched with two respective sides of the nuts having different specifications.

### FIELD OF THE INVENTION

The present invention relates to an improved inner periphery for a wrench wherein two protrusions are located between adjacent recesses in the inner periphery of the driving member.

### BACKGROUND OF THE INVENTION

A conventional driving member for driving but or bolt bead with hexagonal periphery generally includes a six surfaces and six concavities are located between the adjacent surfaces such that the six sides of the nut are matched with the six surfaces and can be rotated. However, there are two different systems for the specifications of the nuts, for example, a 11/16 inch nut is slightly different from a 17-mm nut. There is 0.28 mm in difference for the two nuts so that when the driving member is used to tighten or loosen the two nuts, there will be a gap defined between the inner periphery of the driving member and the nut. Several efforts are developed for overcoming the problems such as the disclosures shown in U.S. Pat. No. 4,765,211, U.S. Pat. No. 3,903,764, U.S. Pat. No. 5,388,486, and U.S. Pat. No. 5,219,392. Most of the efforts use a protrusion at a specific position of the inner periphery of the driving member so that the nuts with different specifications can be secured by the driving member. Nevertheless, the protrusion tends to be worn out because it protrudes along and bears a huge stress frequently. The tool has to be removed from the nut and turned to the other side to match the nut again when using the tool in opposite direction.

The present invention intends to provide a driving member that has an improved inner periphery to accommodate the nuts with different specifications.

### SUMMARY OF THE INVENTION

In accordance with one aspect of the present invention, there is provided a driving member which includes a ring-shaped body having a hole defined therethrough and six concavities are defined equiangularly in an inner periphery of the ring-shaped body. Six engaging portions are located between the six concavities alternatively and each engaging portion includes a first engaging surface and a second engaging surface on two ends of the engaging portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the driving member of the present invention and a tool;

FIG. 2 shows the driving member be accommodated in the tool;

FIG. 3 shows a nut is accommodated in the hole of the driving member;

FIG. 4 shows the driving member is rotated counter clockwise to drive the nut;

FIG. 5 shows the driving member is rotated clockwise to drive the nut; and

FIG. 6 shows another embodiment of the inner periphery of the driving member.

### DETAILED DESCRIPTION OF THE PREFERRED EMBODIMENT

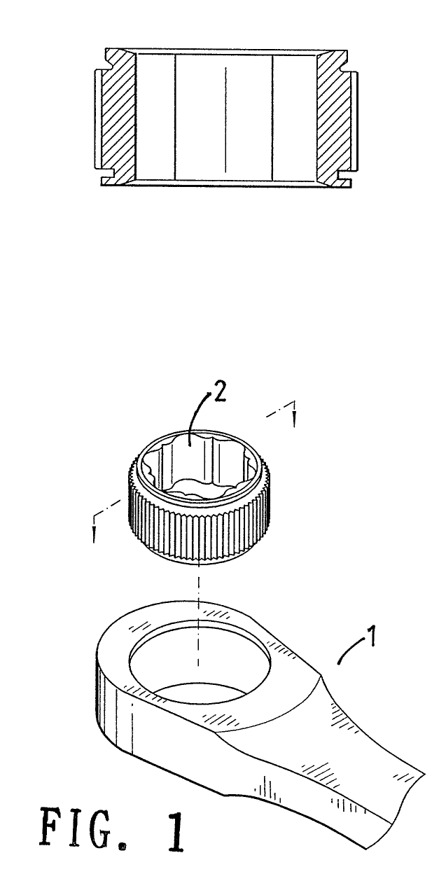

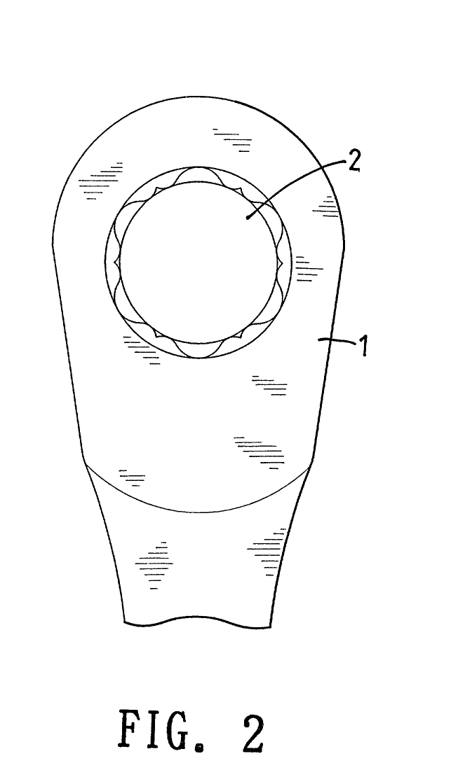

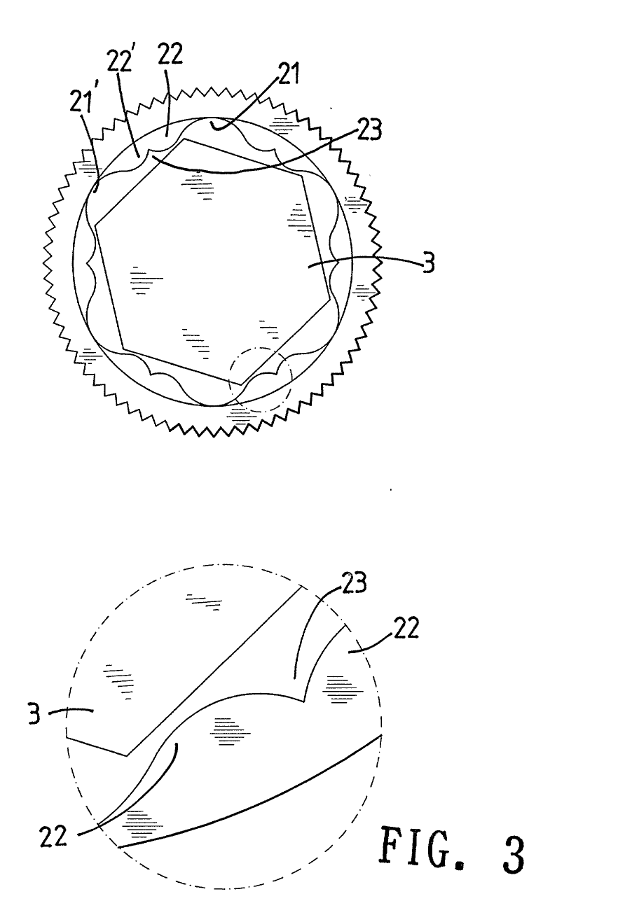

Referring to FIGS. 1 to 3, the driving member of the present invention comprises a ring-shaped body which is received in a box-end wrench 1 and teeth are defined in an outer periphery of the ring-shaped body. A hole 2 is defined through the body and six concavities 21 are defined equiangularly in an inner periphery of the ring-shaped body. Six engaging portions are located between the six concavities 21 alternatively and each engaging portion includes a first profusion 22 and a second protrusion 22′, A recess 23 is defined between the first protrusion 22 and the second protrusion 22′.

A nut 3 is accommodated in the hole 2 of the body and either one of the first protrusion 22 or the second protrusion 22′ contacts a side of the nut 3.

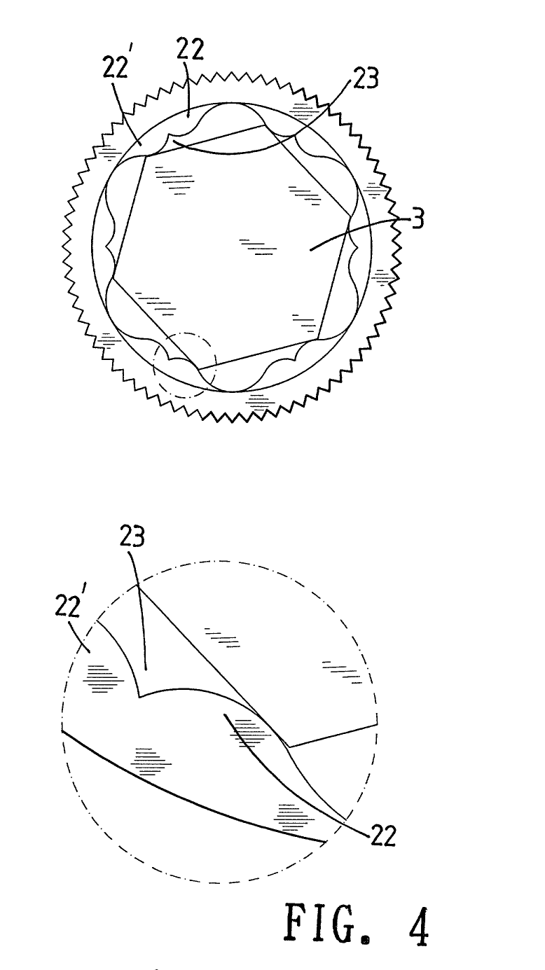

As shown in FIG. 4, when the wrench 1 is to be rotated counter clockwise, the six second protrusions 22′ respectively contact respective one of the six sides of the nut 3 so that when the wrench 1 is rotated counter clockwise, the nut 3 is rotated.

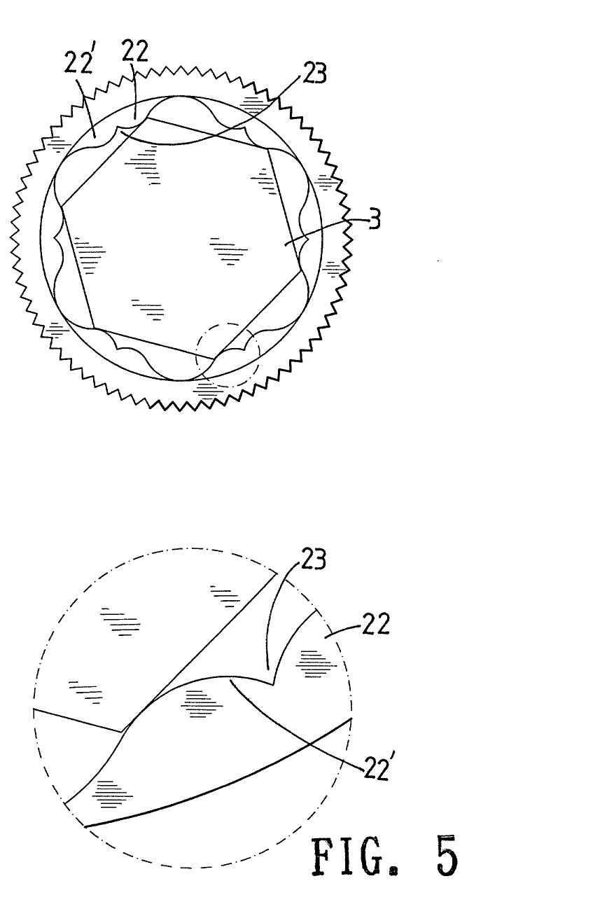

Referring to FIG. 5, when the wrench 1 is to be rotated clockwise, the body is adjusted to let six first protrusions 22 respectively contact respective one of the six sides of the nut 3 so that when the wrench 1 is rotated clockwise, the nut 3 is rotated.

The concavities 21 allow the nuts with different specifications to be accommodate in the hole 2 of the driving member so that the driving member can be used to rotate the nuts 3 with two specifications. Referring to FIG. 4, the distance “A” is short so that the user may adjust the wrench 1 quickly to match the nuts 3.

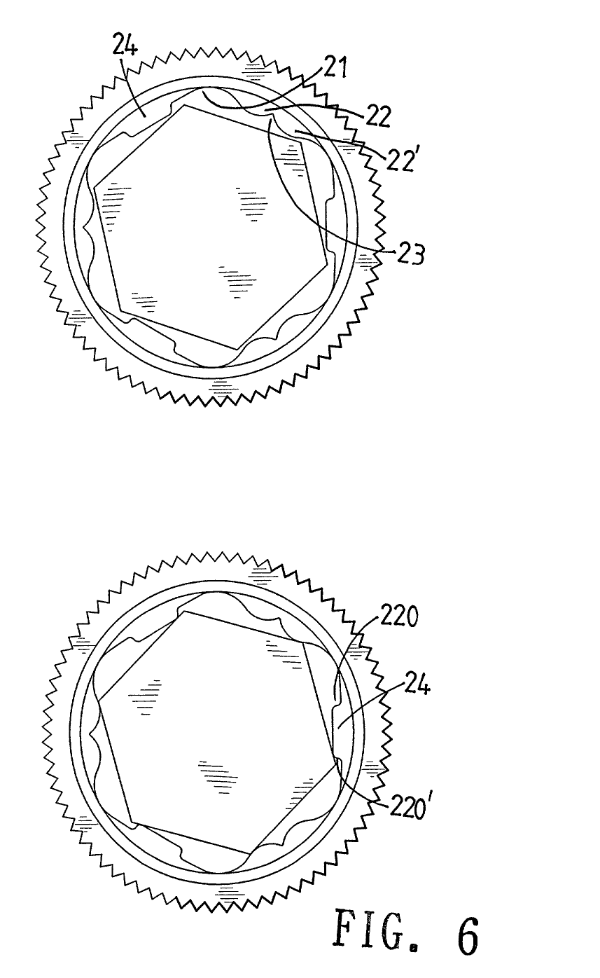

FIG. 6 shows that some of the engaging portions can be simply a rectangular protrusion 24 which includes a first engaging surface 220 and a second engaging surface 220′ on two ends thereof.

While we have shown and described the embodiment in accordance with the present invention, it should be clear to those skilled in the art that further embodiments may be made without departing from the scope of the present invention.

What is claimed is:

1. A driving member comprising:
a ring-shaped body having a hole defined therethrough, six concavities defined equiangulary in an inner periphery of the ring-shaped body, six engaging portions located between the six concavities alternatively and each engaging portion including a first engaging surface and a second engaging surface on two ends of the engaging portion.

2. The device as claimed in claim 1, wherein each engaging portion includes a first protrusion and a second protrusion, a recess defined between the first protrusion and the second protrusion.
